(19) United States
(12) Patent Application Publication
(10) Pub. No.: US 2026/0092192 A1
(43) Pub. Date: Apr. 2, 2026

(54) WOOD-FIBER CEMENT BUILDING PANELS AND METHODS FOR MANUFACTURING

(71) Applicant: ARMSTRONG WORLD INDUSTRIES, INC., Lancaster, PA (US)

(72) Inventor: Steven MASIA, Lancaster, PA (US)

(73) Assignee: ARMSTRONG WORLD INDUSTRIES, INC., Lancaster, PA (US)

(21) Appl. No.: 19/336,673

(22) Filed: Sep. 23, 2025

Related U.S. Application Data
(60) Provisional application No. 63/700,848, filed on Sep. 30, 2024.

(51) Int. Cl. C09D 15/00; C09D 1/02; C09D 1/08; C09D 5/02; C09D 7/65; C09D 191/06; E04C 2/16

(52) U.S. Cl. CPC C09D 15/00; C09D 1/02; C09D 1/08; C09D 5/022; C09D 7/65; C09D 191/06; E04C 2/16

(57) ABSTRACT

A building panel includes a substrate having a first major surface opposing a second major surface. The substrate includes a composite body having a cellulosic matrix and a binder composition including magnesium sulfate and magnesium oxide, a first coating including sodium silicate, and a water-resistant coating including one or more of magnesium sulfate, paraffin, and silicone.

### CROSS-REFERENCE TO RELATED APPLICATION

This Application is a United States Non-Provisional Patent application claiming priority to U.S. Provisional Patent Application No. 63/700,848, filed on Sep. 30, 2024, the entirety of which is incorporated by reference herein.

### TECHNICAL FIELD

The present disclosure relates to building panels and, more specifically, to water resistant, wood-fiber cement building panels.

### BACKGROUND

Wood-fiber cement structures, such as building panels, typically have high porosity. These structures are typically comprised of a material including sodium silicate for desired mechanical properties related to strength and stability. These materials are prone to washing out when subject to rain due to high water solubility.

Accordingly, those skilled in the art continue research and development in the field of wood-fiber cement building panels.

### SUMMARY

The present disclosure is directed to a building panel.

A building panel including a substrate having a first major surface opposing a second major surface. The substrate includes a composite body having a cellulosic matrix and a bonder composition including magnesium sulfate and magnesium oxide, a first coating including sodium silicate, and a water-resistant coating including one or more of magnesium sulfate, paraffin, polyethylene wax, and silicone, or any blends of the above.

In one example, the cellulosic fiber includes a wood fiber, bamboo fiber, or other natural fiber. In another example, the cellulosic fiber is a wood fiber. In another example, the wood fiber includes aspen wood fiber. In one example, the substrate has a porosity ranging from about 50% to about 85%.

In one example, the water-resistant coating includes magnesium sulfate. In one example, the binder composition includes magnesium oxide and magnesium sulfate present in a molar ratio ranging from about 3:1 to about 11:1. In one example, the water-resistant coating includes a methyl hydrogen fluid siliconate with hydroxyl groups on each silicone atom. In one example, the water-resistant coating includes paraffin. In one example, the water-resistant coating includes an anionic paraffin and polyethylene wax emulsion. In one example, the water-resistant coating includes paraffin and a methyl hydrogen fluid siliconate with hydroxyl groups on each silicone atom. In one example, the water-resistant coating has a pH ranging from about 9 to about 11.

Also disclosed is a surface covering system. In one example, the surface covering system includes a plurality of the building panels having a cellulosic matrix and a binder composition including magnesium sulfate and magnesium oxide, a first coating including sodium silicate, and a water-resistant coating including one or more of magnesium sulfate, paraffin, and silicone. In one example, the plurality of building panels are roof decking panels.

Also disclosed is a method for manufacturing a building panel.

In one example, the method includes providing a cellulosic substrate, applying binder a binder composition including magnesium sulfate and magnesium oxide to the cellulosic substrate, applying sodium silicate to the cellulosic substrate, and applying a water-resistant composition including one or more of magnesium sulfate and paraffin to the cellulosic substrate.

In one example, the cellulosic fiber includes a wood fiber, bamboo fiber, or other natural fiber. In another example, the cellulosic fiber is a wood fiber. In another example, the wood fiber includes aspen wood fiber.

In one example, applying the binder composition includes spraying the binder composition including magnesium sulfate and magnesium oxide to the cellulosic substrate. In one example, the binder composition includes magnesium oxide and magnesium sulfate present in a molar ratio ranging from about 3:1 to about 11:1. In one example, applying sodium silicate includes spraying sodium silicate over the substrate after applying the binder composition. In one example, applying the water-resistant composition includes spraying the water-resistant composition over the substrate after applying the sodium silicate. In one example, the water-resistant composition includes a methyl hydrogen fluid siliconate with hydroxyl groups on each silicone atom. In one example, the method further includes applying a crosslinker to the substrate. In one example, the water-resistant composition is applied in an amount ranging from about 20 grams/ft² to about 400 grams/ft².

### BRIEF DESCRIPTION OF THE DRAWINGS

The present invention will become more fully understood from the detailed description and the accompanying drawings, wherein:

FIG. 1 is a top perspective view of a building panel according to the present invention;

FIG. 2 is a cross-sectional view of the building panel according to the present invention; and

FIG. 3 is a surface covering system comprising the building panel of FIG. 1.

### DETAILED DESCRIPTION

The following description of the preferred example(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

The description of illustrative examples according to principles of the present invention is intended to be read in connection with the accompanying drawings, which are to be considered part of the entire written description. In the description of examples of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified examples. Accordingly, the invention expressly should not be limited to such exemplary examples illustrating some possible non-limiting combination of features that may exist alone or in other combinations of features; the scope of the invention being defined by the claims appended hereto.

Unless otherwise specified, all percentages and amounts expressed herein and elsewhere in the specification should be understood to refer to percentages by weight. The amounts given are based on the active weight of the material. According to the present application, the term “about” means+/−5% of the reference value. According to the present application, the term “substantially free” less than about 0.1 wt. % based on the total of the referenced value.

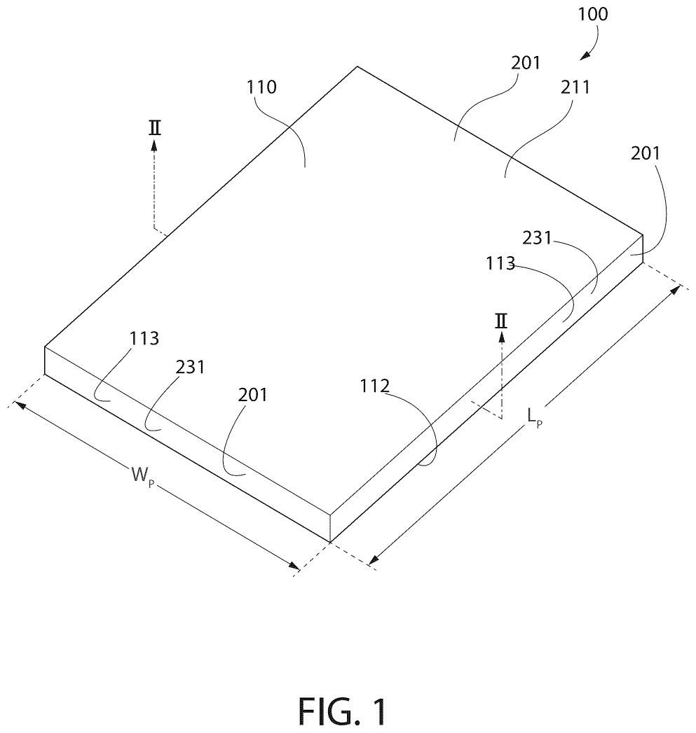

Referring to FIG. 1, disclosed is a building panel 100. The building panel 100 may be a roof decking panel. The building panel 100 includes a substrate 110 having a first major surface 111 opposite a second major surface 112. The ceiling panel 100 may further comprise a side surface 113 that extends between the first major surface 111 and the second major surface 112, thereby defining a perimeter of the ceiling panel 100.

The side surface 113 may comprise a first side surface 113a opposite a second side surface 113b and a third side surface 113c opposite a fourth side surface 113d. The first and second side surfaces 113a, 113b may be substantially parallel. The third and fourth side surfaces 113c, 113d may be substantially parallel. The first and second side surfaces 113a, 113b may be substantially orthogonal to the third and fourth side surface 113c, 113d. The first side surface 113a may intersect the third side surface 113c and the fourth side surface 113d. The second side surface 113b may intersect the third side surface 113c and the fourth side surface 113d.

The building panel 100 may have a panel width Wp as measured by the distance between the first side surface 113a and the second side surface 113b. The panel width Wp may range from about 12 inches to about 48 inches—including all widths and sub-ranges there-between. The building panel 100 may have a panel length L_{P} as measured by the distance between the third side surface 113c and the fourth side surface 113d. The panel length L_{P} may range from about 12 inches to about 96 inches—including all widths and sub-ranges there-between.

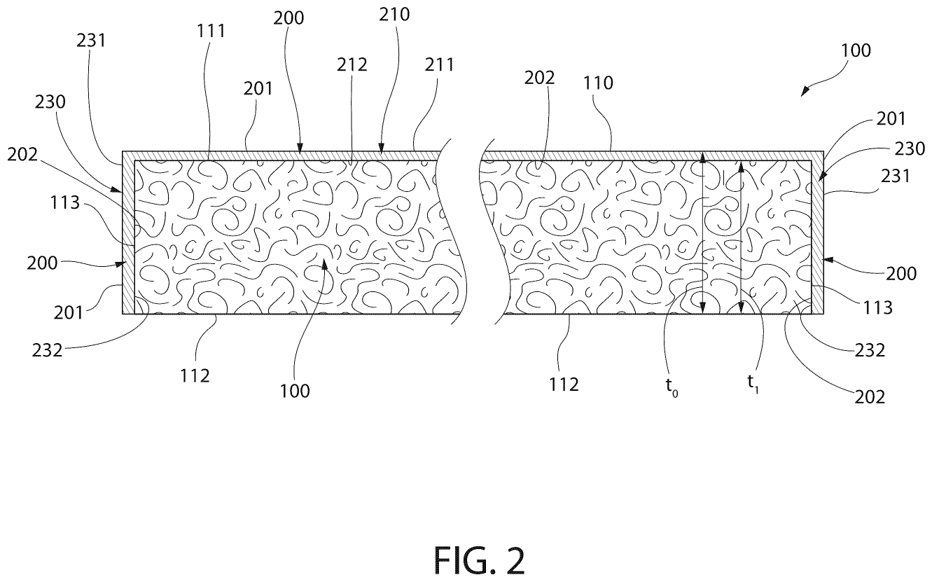

Referring now to FIGS. 1 and 2, the building panel 100 of the present disclosure may have a panel thickness to as measured from the first major exposed surface 111 to the second major exposed surface 112. The panel thickness to may range from about 12 mm to about 40 mm—including all values and sub-ranges there-between.

The building panel 100 may comprise an additional layer, such as a scrim or a surface coating 200 applied thereto. The substrate 110 comprises an upper surface 111 opposite a lower surface 112 and a body side surface 113 that extends between the upper surface 111 and the lower surface 112, thereby defining a perimeter of the body 100. The body 100 may have a body thickness t₁ that as measured by the distance between the upper surface 111 to the lower surface 112 of the body 100. The body thickness t₁ may range from about 12 mm to about 40 mm—including all values and sub-ranges there-between.

In one example, the substrate 110 is a highly porous substrate having a porosity ranging from about 50% to about 85% In one or more examples, the substrate 110 includes a composite body. The composite body has a cellulosic matrix. The cellulosic matrix includes wood fiber. The cellulosic fiber may be a wood fiber, bamboo fiber, or other natural fiber. In a preferred example, the cellulosic fiber is a wood fiber. In a non-limiting example, the wood fiber may comprise aspen wood fiber.

In one or more examples, the composite body includes a binder composition within the cellulosic matrix. The binder composition includes magnesium sulfate (MgSO₄) and magnesium oxide (MgO). In one example, the binder composition is sprayed onto the cellulosic matrix. Upon application to the cellulosic matrix, the binder composition may form magnesium oxysulfate, acting as a green binder for the composite body.

The binder composition may comprise both MgO and MgSO₄ in a molar ratio ranging from about 3:1 to about 11:1—including all ratios and sub-ranges there-between. Phases of MgO—MgSO₄:H₂0 present in the reacted cementitious admixture are desired to be 3:1:8; and 5:1:8′ other crystal phases of 1:1:5, 1:2:2; 1:2:3; 5:1-2; 5-1-3 and 5:1; 7, and potentially residual MgO and or Magnesium sulfate.

In some examples, the binder composition may comprise both MgO and MgSO₄ in a molar ratio ranging from about: 4.0:1 to about 10.0:1—including all ratios and sub-ranges there-between. In some examples, the binder composition may comprise both MgO and MgSO₄ in a molar ratio ranging from about: 5.0:1 to about 10.0:1—including all ratios and sub-ranges there-between. In some examples, the binder composition may comprise both MgO and MgSO₄ in a molar ratio ranging from about: 5.0:1 to about 9.0:1—including all ratios and sub-ranges there-between. In some examples, the binder composition may comprise both MgO and MgSO₄ in a molar ratio ranging from about: 6.0:1 to about 9.0:1—including all ratios and sub-ranges there-between.

In some examples, the binder composition may comprise both MgO and MgSO₄ in a molar ratio ranging from about: 7.0:1 to about 9.0:1—including all ratios and sub-ranges there-between. In some examples, the binder may comprise MgO and MgSO₄ in a molar ratio ranging from about 7.5:1 to about 8.5:1—including all ratios and sub-ranges there-between. In some examples, the binder composition may comprise MgO and MgSO₄ in a molar ratio ranging from about 7.9:1 to about 8.3:1—including all ratios and sub-ranges there-between.

The MgO may be present in the binder composition an amount ranging from about 29 wt. % to about 51 wt. % based on the total weight of the body 120—including all wt. % and sub-ranges there-between. The MgSO₄ may be present in the binder composition an amount ranging from about 10 wt. % to about 22 wt. % based on the total weight of the body 120—including all wt. % and sub-ranges there-between.

In one or more examples, the substrate 110 includes a first coating including sodium silicate, the sodium silicate may be applied by spraying over the composite body. The solidum silicate may be mixed with one or more additives, such as a crosslinker, flame retardant, and antimicrobial agent such that the sodium silicate is concurrently applied with one or more additives. In one non-limiting example, the sodium silicate is applied with potassium methyl siliconate and resin. The first coating may be absorbed into the cellulosic matrix of the substrate 110.

In one or more examples, the substrate 110 includes a water-resistant coating. The water-resistant coating includes one or more of magnesium sulfate, paraffin, and silicone. In one example, the water-resistant coating includes wax beads. The water-resistant coating may be absorbed into the cellulosic matrix of the substrate 110.

In one example, the water-resistant coating includes a methyl hydrogen fluid siliconate with hydroxyl groups on each silicone atom. In another example, the water-resistant coating includes paraffin. In a non-limiting example, the water-resistant coating includes an anionic paraffin and polyethylene wax emulsion. In another example, the water-resistant coating includes paraffin and a methyl hydrogen fluid siliconate with hydroxyl groups on each silicone atom. In a further example, the water-resistant coating has a pH ranging from about 9 to about 11.

In one example, the water-resistant coating is applied in an amount ranging from about 20 to about 25 grams/ft² of a 20% solution of a paraffin/polythene wax emulsion. In another example, the water-resistant coating is applied in an amount ranging from about 42 to about 45 grams/ft² of a 20% solution of a paraffin polyethylene wax emulsion. In another example, the water-resistant coating is applied in an amount ranging from about 80 to about 90 grams/ft² of a 20% solution of a paraffin/polyethylene wax emulsion.

In one example, the water-resistant coating is applied in an amount of about 130 grams of a 20% magnesium sulfate solution containing 3 wt. % of a silicone that contains a hydrogen group on each silicone atom. In one example, the water-resistant coating is applied in an amount of about 260 grams of a 20% magnesium sulfate solution containing 3 wt. % of a silicone that contains a hydrogen group on each silicone atom. In another example, the water-resistant coating is applied in an amount of about 390 grams of a 20% magnesium sulfate solution containing 3 wt. % of a silicone that contains a hydrogen group on each silicone atom.

In one or more examples, the building panel 100 may be characterized by its fire resistant material properties. The fire resistance of the building panel 100 may be characterized by its Fire Rating properties. In one example, the building panel 100 is fire resistant such that it has a FSR rating of ASTM E84 Class B or Class A (FSI less than 25, SDI less than 450).

In one or more examples, the building panel 100 may be characterized by its acoustic properties. The building panel 100 may be an acoustic panel such that it provides desirable acoustic properties. NRC is a measure of sound energy absorption of a material. An NRC rating of 0 is a perfect sound reflection material. An NRC rating of 1 is a perfect sound absorption material. In one example, the building panel 100 exhibits an NRC value greater than 0.7. In another example, the building panel 100 exhibits an NRC value greater than 0.75. In yet another example, the building panel 100 exhibits an NRC value greater than 0.8, 0.85, or 0.9.

Also disclosed is a surface covering system. In one example, the surface covering system includes a plurality of the building panels having a cellulosic matrix and a binder composition including magnesium sulfate and magnesium oxide, a first coating including sodium silicate, and a water-resistant coating including one or more of magnesium sulfate, paraffin, and silicone. In one example, the plurality of building panels are roof decking panels.

Also disclosed is a method for manufacturing a building panel 100. In one example, the method includes providing a cellulosic substrate 110. In one example, the substrate 110 is a highly porous substrate having a porosity ranging from about 50% to about 85%. In one or more examples, the substrate 110 includes a composite body. The composite body has a cellulosic matrix. The cellulosic matrix includes wood fiber. The cellulosic fiber may be a wood fiber, bamboo fiber, or other natural fiber. In a preferred example, the cellulosic fiber is a wood fiber. In a non-limiting example, the wood fiber may comprise aspen wood fiber.

In one example, the method includes applying a binder composition including magnesium sulfate and magnesium oxide to the cellulosic substrate. In one example, applying the binder composition includes spraying the binder composition including magnesium sulfate and magnesium oxide to the cellulosic substrate.

The binder composition may comprise both MgO and MgSO₄ in a molar ratio ranging from about 3:1 to about 11:1—including all ratios and sub-ranges there-between. Phases of MgO—MgSO₄:H₂0 present in the reacted cementitious admixture are desired to be 3:1:8; and 5:1:8′ other crystal phases of 1:1:5, 1:2:2; 1:2:3; 5:1-2; 5-1-3 and 5:1; 7, and potentially residual MgO and or Magnesium sulfate.

In some examples, the binder composition may comprise both MgO and MgSO₄ in a molar ratio ranging from about: 4.0:1 to about 10.0:1—including all ratios and sub-ranges there-between. In some examples, the binder composition may comprise both MgO and MgSO₄ in a molar ratio ranging from about: 5.0:1 to about 10.0:1—including all ratios and sub-ranges there-between. In some examples, the binder composition may comprise both MgO and MgSO₄ in a molar ratio ranging from about: 5.0:1 to about 9.0:1—including all ratios and sub-ranges there-between. In some examples, the binder composition may comprise both MgO and MgSO₄ in a molar ratio ranging from about: 6.0:1 to about 9.0:1—including all ratios and sub-ranges there-between.

In some examples, the binder composition may comprise both MgO and MgSO₄ in a molar ratio ranging from about: 7.0:1 to about 9.0:1—including all ratios and sub-ranges there-between. In some examples, the binder may comprise MgO and MgSO₄ in a molar ratio ranging from about 7.5:1 to about 8.5:1—including all ratios and sub-ranges there-between. In some examples, the binder composition may comprise MgO and MgSO₄ in a molar ratio ranging from about 7.9:1 to about 8.3:1—including all ratios and sub-ranges there-between.

The MgO may be present in the binder composition an amount ranging from about 29 wt. % to about 51 wt. % based on the total weight of the body 120—including all wt. % and sub-ranges there-between. The MgSO₄ may be present in the binder composition an amount ranging from about 10 wt. % to about 22 wt. % based on the total weight of the body 120—including all wt. % and sub-ranges there-between.

In one example, the method includes applying sodium silicate to the cellulosic substrate 110. In one example, applying sodium silicate includes spraying sodium silicate over the substrate after applying the binder composition such that the sodium silicate is absorbed into the cellulosic matrix.

In one example, the method includes applying a water-resistant composition including one or more of magnesium sulfate and paraffin to the cellulosic substrate 110. In one example, applying the water-resistant composition includes spraying the water-resistant composition over the substrate 110 after applying the sodium silicate such that it is absorbed into the cellulosic matrix.

In one example, the water-resistant composition includes a methyl hydrogen fluid siliconate with hydroxyl groups on each silicone atom. In another example, the method further includes applying a crosslinker to the substrate 110.

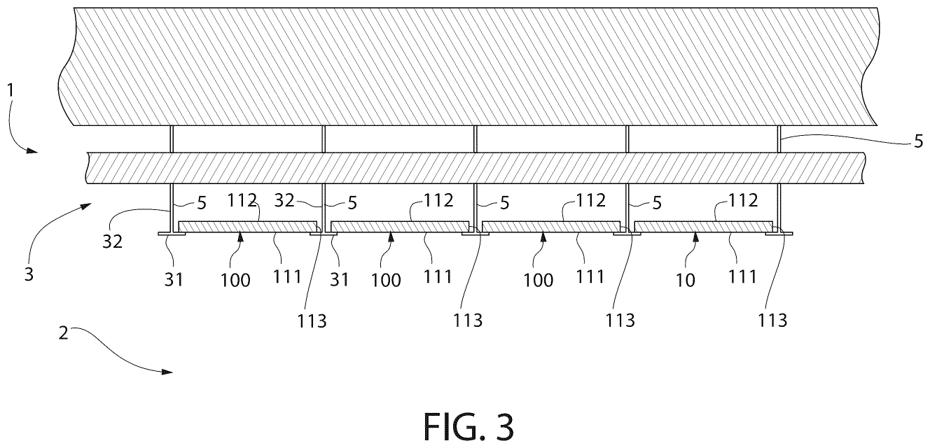

Referring to FIG. 3, the present invention may further include a surface covering system 1 comprising one or more of the building panels 100 installed in an interior space 8. The interior space 8 may comprise a floor surface 4 that is opposite a ceiling surface 5. The interior space 8 may further comprise a cavity space 3 and an active room environment 2. The cavity space 3 may provide a free volume for joists and/or wall stud 9 to be located within the surface covering system 1. The active room environment 2 provides room for the building occupants during normal intended use of the building (e.g., in an office building, the active space would be occupied by offices containing computers, lamps, etc.). The floor surface 4 provides for building occupants to walk on within the room environment 2. The floor surface 4 may extend into the cavity space 3. The floor surface 4 may be formed a building material (e.g., wood flooring, concrete flooring, metal grate, etc.).

In the installed state, the building panels 100 may be supported in the interior space 8 by one or more of the wall studs 9 (for building panels 100 that function as wall panels) and/or one or more of the ceiling joists (for building panels 100 that function as ceiling panels-not pictured). In the installed state, the plurality of building panels 100 supported by the wall studs 9 may form a wall surface 50. In the installed state, the plurality of building panels 100 supported by the ceiling joists may form a ceiling surface 5.

The plurality of wall studs 9 may be arranged substantially parallel to each other. The plurality of wall studs 9 may be offset from each other by a distance D_{WS} of about 16 inches—as measured on center from each adjacent wall stud 9. The distance D_{WS} between wall studs 9 may provide for an open cavity volume 11. The open cavity volume 11 may be an unoccupied space within the surface covering system 1. In other embodiments, insulation may be installed into the open cavity volume 11—non-limiting examples of insulation include sound insulation, thermal insulation, and combinations thereto.

The wall studs 9 may be an elongated body having a substantially vertical orientation—extending in a direction that spans between the floor surface 4 and the ceiling surface 5. Depending on the room layout design, the wall studs 9 may be oriented orthogonal to the floor surface 4—i.e., resulting in a wall surface 50 that is completely vertical (also referred to as a “vertical wall surface” 50). In other embodiments, the wall studs 9 may be oriented at an angle between about 46° to about 89° relative to the floor surface 4—i.e., resulting in a wall surface 50 that is slanted (also referred to as a “slanted wall surface” 50).

Depending on the room layout design, the ceiling surface 5 may be substantially parallel to the floor surface 4—i.e., resulting in a ceiling surface 5 that is completely horizontal (also referred to as a “horizontal ceiling surface” 5). In other embodiments, the ceiling surface 5 may be oriented at an angle between about 1° to about 44° relative to the floor surface 4—i.e., resulting in a ceiling surface 5 that is slanted (also referred to as a “slanted ceiling surface” 5).

The cavity space 3 may exist behind each one of the plurality of building panels 100. The active room environment 2 may exists in front of each one of the plurality of building panels 100. The first major surface 111 of the building panel 100 may face the active room environment 2. The second major surface 112 of the building panel 100 may face the cavity space 3. As discussed further herein, the building panels 100 of the present invention have airflow properties required for the building panels 100 to functional as acoustical building panels—as discussed further herein.

In a non-limiting embodiment, the building panels 100 may be supported by the one or more of the wall studs 9 using a mechanical fastener (e.g., screw), adhesive, or combinations thereto. In a non-limiting embodiment, the building panels 100 may be support by the one or more ceiling joists using a mechanical fastener (e.g., screw), adhesive, or combinations thereof.

The building panels 100 may be positioned within surface covering system 1 such that at least one of the side surfaces 113 is located adjacent to the floor surface 4. Specifically, the first side surface 113a (or second side surface 113b) may be located adjacent to the floor surface 4—whereby in such arrangement, the wall panel 100 is vertically oriented in a sideways manner (not pictured). The wall panel 100 vertically oriented in the sideways manner may comprise the third side surface 113c and the fourth side surface 113d being substantially parallel to the elongated body of the wall studs 9—whereby each one of the third side surface 113c and/or fourth side surface 113d may overlap with a single wall stud 9. The wall panel 100 vertically oriented in the sideways manner may comprise the first side surface 113a and the second side surface 113b being substantially orthogonal to the elongated body of the wall studs 9—whereby each one of the first side surface 113a and/or second side surface 113b may overlap with a plurality of wall studs 9.

In other embodiments, the building panels 100 may be positioned within surface covering system 1 such that at least one of the side surfaces 113 is located adjacent to the floor surface 4 such that the third side surface 113c (or fourth side surface 113d) may be located adjacent to the floor surface 4—whereby in such arrangement, the wall panel 100 is vertically oriented in an upstanding manner (as pictured in FIG. 3). The wall panel 100 vertically oriented in the upstanding manner may comprise the first side surface 113a and the second side surface 113b being substantially parallel to the elongated body of the wall studs 9—whereby each one of the first side surface 113a and/or second side surface 113b may overlap with a single wall stud 9. The wall panel 100 vertically oriented in the upstanding manner may comprise the third side surface 113c and the fourth side surface 113d being substantially orthogonal to the elongated body of the wall studs 9—whereby each one of the third side surface 113c and/or fourth side surface 113d may overlap with a plurality of wall studs 9.

A plurality of building panel seams 52 may exist between side surfaces 113 of two adjacent-most building panels 100. In a non-limiting example, FIG. 3 demonstrates that a first building panel 100a and a second building panel 100b may be positioned adjacent to each other, whereby a panel seam 52 is located where the first side surface 113a of the first building panel 100a is located adjacent to the second side surface 113b of the second building panel 100b. The building panel seam 52 may substantially overlap with the wall studs 9 in a vertical direction. Although not pictured, depending on the arrangement of building panels 100, the building panel seam 52 may substantially overlap with the wall studs 9 in a horizontal direction.

Although not pictured, the building panel seams 52 may be formed by the third side surface 113c of a first building panel and the fourth side surface 113d of a second building panel. Although not pictured, the building panel seams 52 may be formed by the first side surface 113a (or second side surface 113b) of a first building panel and the third side surface 113c (or fourth side surface 113d) of a second building panel.

In the installed state, the building panel 100 may be secured to one or more of the wall studs 9 such that the building panel 100 is located from the floor surface 4 by a panel-floor distance D_{PF}. The panel-floor distance DPF may be determined by the vertical distance spanning between the floor surface 4 and the most-proximate point on the building panel 100 from the floor surface 4. The panel-floor distance D_{PF} may range from zero to about 8 feet—including all distances and sub-ranges there-between. The panel-floor distance D_{PF} may range from zero to about 6 feet—including all distances and sub-ranges there-between. When the panel-floor distance D_{PF} is zero, the building panel 100 may be in direct contact with the floor surface 4. In some embodiments, the panel-floor distance D_{PF} is less than about 6 feet.

In other embodiments, the building panel 100 may also be installed such that it forms a ceiling surface (not pictured) and/or be position above the panel-floor distance D_{PF}.

### EXAMPLES

The following examples are representative of the disclosure herein. Samples aspen wood composite panels of various thickness were coated with different amounts of water-resistant coatings as further described below to test for fire rating and water absorption. Samples included the following:

(Sample 1) 1″ thick composite panel coated with 20-25 grams/ft² of a 20% solution of a paraffin/polythene wax emulsion.

(Sample 2) 2″ thick composite panel coated with 42-45 grams/ft² of a 20% solution of a paraffin polyethylene wax emulsion.

(Sample 3) 3″ thick composite panel coated with 80-90 grams/ft² of a 20% solution of a paraffin/polyethylene wax emulsion.

(Sample 4) 1″ thick composite panel coated with ˜130 grams of a 20% magnesium sulfate solution containing 3 wt. % of a silicone that contains a hydrogen group on each silicone atom.

(Sample 5) 2″ thick composite panel coated with ˜260 grams of a 20% magnesium sulfate solution containing 3 wt. % of a silicone that contains a hydrogen group on each silicone atom.

(Sample 6) 3″ thick composite panel coated with ˜390 grams of a 20% magnesium sulfate solution containing 3 wt. % of a silicone that contains a hydrogen group on each silicone atom.

Table 1 illustrates Testing Data for samples tested per ASTM E2768-11 (2019) Standard Test Method for Extended Duration Surface Burning Characteristics of Building Materials (30 min Tunnel Test). E-84 is the standard test method for assessing the surface burning characteristics of building products. The purpose of this test is to observe the flame spread along with a sample in order to determine the relative burning behavior of its material. Through the E84 test, both the Flame Spread Index (FSI) and Smoke Developed Index (SDI) are reported for a given sample. FSI is the measurement for the speed at which flames progress across the interior surface of a building, while SDI measures the amount of smoke a sample emits as it burns. In order to qualify as an E84 Class A fire rating, a flame spread index of 25 or less and smoke developed index at 450 or less must be exhibited. Flame characterization was performed either on a backing itself or on a panel having a backing.

TABLE 1

| | | Flame Spread Index | Max Flame Spread |
|---|---|---|---|
| Sample | Thickness | (FSI) | Distance (ft) |
| 1 | 1″ | 0 | 0 |
| 2 | 2″ | 0 | 0 |
| 3 | 3″ | 0 | 0 |
| 4 | 1″ | 0 | 0 |
| 5 | 2″ | 0 | 0 |
| 6 | 3″ | 0 | 0 |

As shown in Table 1, all samples with the disclosed composition exhibited desired FSI results. It was further observed in all samples that no material leaked out from the bottom of the substrates. Thus, the additional material applied was absorbed by the composite substrates.

To obtain water repellent with a paraffin polyethylene wax emulsion, the disclosed composition was applied at a rate of 2 to 5 dry wt. % (preferably 2.5 to 3.5 dry wt. %) of the composite substrate of the total weight of the composite substrate. Due to its viscosity, the paraffin/polyethylene wax emulsion must be diluted to a total of 20% solids for it to diffuse evenly into the composite substrate. The resultant ASTM 85 fire testing are shown below in Table 2.

TABLE 2

| | | Flame Spread Index | Max Flame Spread |
|---|---|---|---|
| Sample | Thickness | (FSI) | Distance (ft) |
| 1 | 1″ | 0 | 0 |
| 2 | 1.5″ | 0 | 0 |
| 3 | 3″ | 0 | 0 |

### Exemplary Claims

The disclosure may be characterized by the following Exemplary Claims:

Exemplary claim 1. A building panel comprising: a substrate having a first major surface opposing a second major surface, the substrate comprising: a composite body comprising a cellulosic matrix and a binder composition comprising magnesium sulfate and magnesium oxide; a first coating comprising sodium silicate; and a water-resistant coating comprising one or more of magnesium sulfate, paraffin, and silicone.

Exemplary claim 2. The building panel according to Exemplary claim 1, wherein the cellulosic matrix comprises wood fibers.

Exemplary claim 3. The building panel according to Exemplary claim 1, wherein the cellulosic matrix comprises aspen wood fibers.

Exemplary claim 4. The building panel according to Exemplary claim 1, wherein the substrate has a porosity ranging from about 50% to about 85%.

Exemplary claim 5. The building panel according to Exemplary claim 1, wherein the binder composition comprises magnesium oxide and magnesium sulfate present in a molar ratio ranging from about 3:1 to about 11:1.

Exemplary claim 6. The building panel according to Exemplary claim 1, wherein the water-resistant coating comprises magnesium sulfate.

Exemplary claim 7. The building panel according to Exemplary claim 1, wherein the water-resistant coating comprises a methyl hydrogen fluid siliconate with hydroxyl groups on each silicone atom.

Exemplary claim 8. The building panel according to Exemplary claim 1, wherein the water-resistant coating comprises paraffin.

Exemplary claim 9. The building panel according to Exemplary claim 1, wherein the water-resistant coating comprises an anionic paraffin and polyethylene wax emulsion.

Exemplary claim 10. The building panel according to Exemplary claim 1, wherein the water-resistant coating comprises paraffin and a methyl hydrogen fluid siliconate with hydroxyl groups on each silicone atom.

Exemplary claim 11. The building panel according to Exemplary claim 1, wherein the water-resistant coating is present from about 25 grams/ft² to about 100 grams/ft².

Exemplary claim 12. The building panel according to Exemplary claim 1, wherein the water-resistant coating has a pH ranging from about 9 to about 11.

Exemplary claim 13. The building panel according to Exemplary claim 1, wherein the building panel is a ceiling panel.

Exemplary claim 14. A surface covering system comprising a plurality of the building panel according to any one of Exemplary claims 1 to 13.

Exemplary claim 15. The surface covering system according to Exemplary claim 14, wherein the plurality of building panels are roof decking panels.

Exemplary claim 16. The surface covering system according to Exemplary claim 14, wherein the plurality of building panels are ceiling panels.

Exemplary claim 17. A method for manufacturing a building panel comprising: providing a cellulosic substrate; applying a binder composition comprising magnesium sulfate and magnesium oxide to the cellulosic substrate; applying sodium silicate to the cellulosic substrate; and applying a water-resistant composition comprising one or more of magnesium sulfate and paraffin to the cellulosic substrate.

Exemplary claim 18. The method according to Exemplary claim 17, wherein the cellulosic substrate comprises wood fibers.

Exemplary claim 19. The method according to Exemplary claim 17, wherein the cellulosic substrate comprises aspen wood fibers.

Exemplary claim 20. The method according to Exemplary claim 17, wherein applying the binder composition comprises spraying the binder composition comprising magnesium sulfate and magnesium oxide to the cellulosic substrate

Exemplary claim 21. The method according to Exemplary claim 17, wherein applying sodium silicate comprises spraying sodium silicate over the substrate after applying the binder composition.

Exemplary claim 22. The method according to Exemplary claim 17, wherein applying the water-resistant composition comprises spraying the water-resistant composition over the substrate after applying the sodium silicate.

Exemplary claim 23. The method according to Exemplary claim 17, wherein the water-resistant composition comprises a methyl hydrogen fluid siliconate with hydroxyl groups on each silicone atom.

Exemplary claim 24. The method according to Exemplary claim 17, further comprising applying a crosslinker to the substrate.

Exemplary claim 25. The method according to Exemplary claim 17, wherein the binder composition comprises magnesium oxide and magnesium sulfate present in a molar ratio ranging from about 3:1 to about 11:1.

Exemplary claim 26. The method according to Exemplary claim 17, wherein the water-resistant composition is applied in an amount ranging from about 20 grams/ft² to about 400 grams/ft².

While the present disclosure has been described with reference to several examples, which examples have been set forth in considerable detail for the purposes of making a complete disclosure of the disclosure, such examples are merely representative and are not intended to be limiting or represent an exhaustive enumeration of all aspects of the disclosure. The scope of the disclosure is to be determined from the claims appended hereto. Further, it will be apparent to those of skill in the art that numerous changes may be made in such details without departing from the spirit and the principles of the disclosure.

What is claimed is:

1. A building panel comprising:
a substrate having a first major surface opposing a second major surface, the substrate comprising:
a composite body comprising a cellulosic matrix and a binder composition comprising magnesium sulfate and magnesium oxide;
a first coating comprising sodium silicate; and
a water-resistant coating comprising one or more of magnesium sulfate, paraffin, and silicone.

2. The building panel according to claim 1, wherein the cellulosic matrix comprises aspen wood fibers.

3. The building panel according to claim 1, wherein the substrate has a porosity ranging from about 50% to about 85%.

4. The building panel according to claim 1, wherein the binder composition comprises magnesium oxide and magnesium sulfate present in a molar ratio ranging from about 3:1 to about 11:1.

5. The building panel according to claim 1, wherein the water-resistant coating comprises magnesium sulfate.

6. The building panel according to claim 1, wherein the water-resistant coating comprises a methyl hydrogen fluid siliconate with hydroxyl groups on each silicone atom.

7. The building panel according to claim 1, wherein the water-resistant coating comprises paraffin.

8. The building panel according to claim 1, wherein the water-resistant coating comprises an anionic paraffin and polyethylene wax emulsion.

9. The building panel according to claim 1, wherein the water-resistant coating comprises paraffin and a methyl hydrogen fluid siliconate with hydroxyl groups on each silicone atom.

10. The building panel according to claim 1, wherein the water-resistant coating is present from about 25 grams/ft² to about 100 grams/ft².

11. The building panel according to claim 1, wherein the water-resistant coating has a pH ranging from about 9 to about 11.

12. A method for manufacturing a building panel comprising:
providing a cellulosic substrate;
applying a binder composition comprising magnesium sulfate and magnesium oxide to the cellulosic substrate;
applying sodium silicate to the cellulosic substrate; and
applying a water-resistant composition comprising one or more of magnesium sulfate and paraffin to the cellulosic substrate.

13. The method according to claim 12, wherein the cellulosic substrate comprises aspen wood fibers.

14. The method according to claim 12, wherein applying the binder composition comprises spraying the binder composition comprising magnesium sulfate and magnesium oxide to the cellulosic substrate

15. The method according to claim 12, wherein applying sodium silicate comprises spraying sodium silicate over the substrate after applying the binder composition.

16. The method according to claim 12, wherein applying the water-resistant composition comprises spraying the water-resistant composition over the substrate after applying the sodium silicate.

17. The method according to claim 12, wherein the water-resistant composition comprises a methyl hydrogen fluid siliconate with hydroxyl groups on each silicone atom.

18. The method according to claim 12, further comprising applying a crosslinker to the substrate.

19. The method according to claim 12, wherein the binder composition comprises magnesium oxide and magnesium sulfate present in a molar ratio ranging from about 3:1 to about 11:1.

20. The method according to claim 12, wherein the water-resistant composition is applied in an amount ranging from about 20 grams/ft² to about 400 grams/ft².
